(19) United States
(12) Patent Application Publication
(10) Pub. No.: US 2017/0115805 A1
(43) Pub. Date: Apr. 27, 2017

(54) TOUCH PANEL AND MANUFACTURING METHOD THEREOF

(71) Applicant: HENGHAO TECHNOLOGY CO., LTD, Hsin-chu County (TW)

(72) Inventors: Chun-Lung Chiang, Taichung City (TW); Masanori Yuki, Chiba (JP); Ching-Fang Wong, Taichung City (TW)

(73) Assignee: HENGHAO TECHNOLOGY CO., LTD, Hsin-chu County (TW)

(21) Appl. No.: 15/275,487

(22) Filed: Sep. 26, 2016

(30) Foreign Application Priority Data
Oct. 22, 2015 (TW) 104134614

(51) Int. Cl. G06F 3/041; G06F 3/044

(52) U.S. Cl. CPC G06F 3/0416; G06F 3/044; G06F 2203/04103

(57) ABSTRACT

A touch panel including a substrate, a plurality of first electrodes, a plurality of second electrodes, a patterned insulating layer, a plurality of metal wirings, and a plurality of transparent wirings is provided. Each of the first electrodes includes a plurality of first electrode pads and at least one first connecting portion. Each first connecting portion connects the first electrode pads in series along a first direction. Each of the second electrodes includes a plurality of second electrode pads and a plurality of second connecting portions. Each of the second connecting portions connects two adjacent second electrode pads in series along a second direction. The patterned insulating layer covers the first connecting portions. Each of the transparent wirings is electrically connected to and overlapped with one of the metal wirings. A manufacturing method of the touch panel is also provided.

### CROSS-REFERENCE TO RELATED APPLICATION

This application claims the priority benefit of Taiwan application serial no. 104134614, filed on Oct. 22, 2015. The entirety of the above-mentioned patent application is hereby incorporated by reference herein and made a part of this specification.

### BACKGROUND OF THE INVENTION

Field of the Invention

The invention relates to a panel and a manufacturing method thereof, and more particularly, to a touch panel and a manufacturing method thereof.

Description of Related Art

With the rapid development in information products such as information techniques, wireless mobile communication, and information appliances, to achieve the objects of portability, small size, and ease of use, the input apparatus of many information products has changed from the traditional keyboard or mouse to a touch panel.

In terms of mutual capacitance touch detection techniques, electrodes disposed in a staggered manner often need to be formed in the touch panel to determine the location of touch using the change in capacitance value between the electrodes caused by a touch object on the touch panel. In prior art, at least five lithography processes are needed to form the touch panel. In the structure in which each of the electrodes is formed by a double transparent conductive layer, up to six lithography processes are needed. Moreover, in the structure in which the electrodes adopt a double transparent conductive layer, wirings located in the periphery are formed together with the electrodes. However, the impedance value of the wirings formed by the transparent conductive layer is quite high, which is not good for signal transmission, and therefore the touch sensitivity of the touch panel is poor.

### SUMMARY OF THE INVENTION

The invention provides a manufacturing method of a touch panel capable of reducing the quantity of lithography processes.

The invention provides a touch panel having good touch sensitivity.

The manufacturing method of a touch panel of the invention includes the following steps: forming a first transparent conductive material layer on a substrate; patterning the first transparent conductive material layer to form in a first transparent conductive layer having a plurality of openings, wherein the openings define a plurality of first connecting portions; foil ling a patterned insulating layer on the substrate, wherein the patterned insulating layer covers the openings and the first connecting portions; forming a plurality of metal wirings on the substrate; forming a second transparent conductive material layer on the substrate; and patterning the second transparent conductive material layer and the first transparent conductive layer to form a plurality of first electrode pads, a plurality of second electrode pads, a plurality of second connecting portions, and a plurality of transparent wirings, wherein the first connecting portions connect the first electrode pads in series along a first direction to form a plurality of first electrodes, the second connecting portions connect the second electrode pads in series along a second direction to form a plurality of second electrodes, the second electrodes are electrically insulated from the first electrodes via the patterned insulating layer, and each of the transparent wirings connects one of the first electrodes or one of the second electrodes respectively, wherein each of the transparent wirings is electrically connected to one of the metal wirings respectively and overlapped with the one of the metal wirings.

A touch panel of the invention includes a substrate, a plurality of first electrodes, a plurality of second electrodes, a patterned insulating layer, a plurality of metal wirings, and a plurality of transparent wirings. The first electrodes are disposed on the substrate, each of the first electrodes includes a plurality of first electrode pads and at least one first connecting portion, and each first connecting portion connects the first electrode pads in series along a first direction. The second electrodes are disposed on the substrate and are disposed with the first electrodes in a staggered manner. Each of the second electrodes includes a plurality of second electrode pads and a plurality of second connecting portions. Each of the second connecting portions connects two adjacent second electrode pads in series along a second direction. The patterned insulating layer is disposed on the substrate and covers the first connecting portions. The metal wirings are disposed on the substrate, and each of the metal wirings is electrically connected to one of the first electrodes or one of the second electrodes. The transparent wirings are disposed on the substrate, and each of the transparent wirings is electrically connected to one of the first electrodes or one of the second electrodes, wherein each of the transparent wirings is electrically connected to one of the metal wirings respectively and overlapped with the one of the metal wirings.

Based on the above, the touch panel of the invention reduces the impedance of the signal transmission path via the metal wirings, and therefore the touch panel can have good touch sensitivity. Moreover, in the manufacturing method of the touch panel, openings are formed on the first transparent conductive material layer to define the first connecting portions, and then the second transparent conductive material layer and the first transparent conductive layer are patterned together to form the first electrode pads, the second electrode pads, the second connecting portions, and the transparent wirings. Therefore, the manufacturing method of the touch panel of the invention can reduce the quantity of lithography processes.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A to FIG. 1I are top schematic diagrams of a manufacturing process of a touch panel according to the first embodiment of the invention.

FIG. 1J and FIG. 1K are respectively cross-sectional schematic diagrams along line I-I′ and line II-II′ in FIG. 11.

FIG. 1L is a top schematic diagram of the metal layer in FIG. 1I.

FIG. 1M is a top schematic diagram of the first transparent conductive layer in FIG. 1I.

FIG. 2A is a top schematic diagram of another embodiment of the first transparent conductive layer in FIG. 1D.

FIG. 2B is a top schematic diagram of the first transparent conductive layer of FIG. 2A after the patterning process of FIG. 1H.

FIG. 3A to FIG. 3E are partial top schematic diagrams of a manufacturing process of a touch panel according to the second embodiment of the invention.

FIG. 4A to FIG. 4E are partial top schematic diagrams of a manufacturing process of a touch panel according to the third embodiment of the invention.

FIG. 5A to FIG. 5B are partial top schematic diagrams of a manufacturing process of a touch panel according to the fourth embodiment of the invention.

FIG. 6A to FIG. 6C are partial top schematic diagrams of a manufacturing process of a touch panel according to the fifth embodiment of the invention.

FIG. 7A to FIG. 7E are partial top schematic diagrams of a manufacturing process of a touch panel according to the sixth embodiment of the invention.

FIG. 8A to FIG. 8D are top schematic diagrams of a manufacturing process of a touch panel according to the seventh embodiment of the invention.

FIG. 8E and FIG. 8F are respectively cross-sectional schematic diagrams along line I-I′ and line II-II′ in FIG. 8D.

### DESCRIPTION OF THE EMBODIMENTS

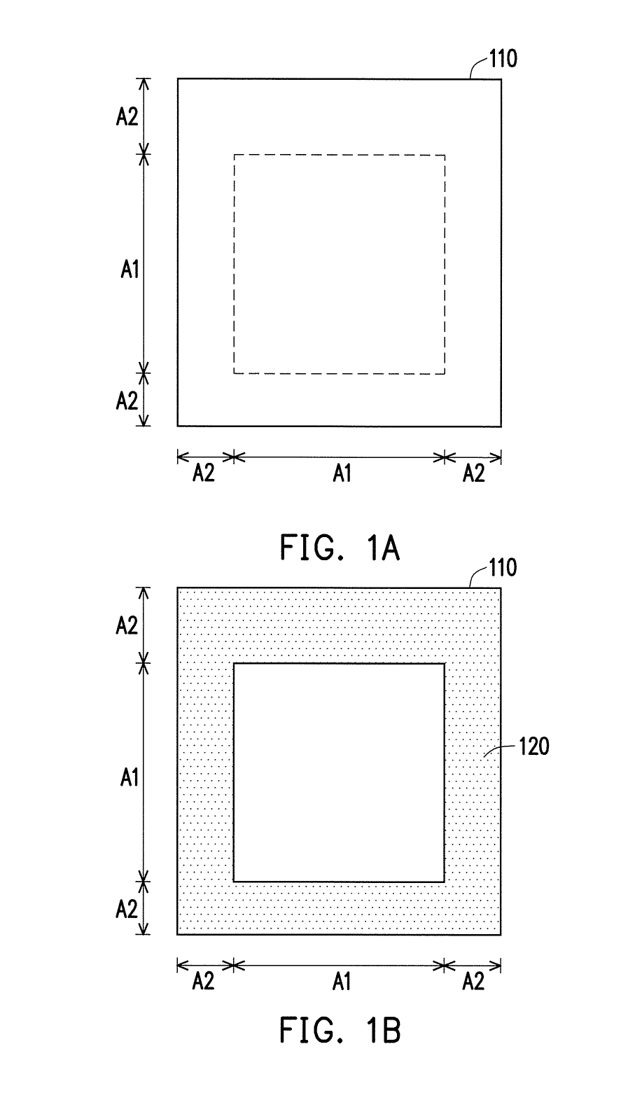

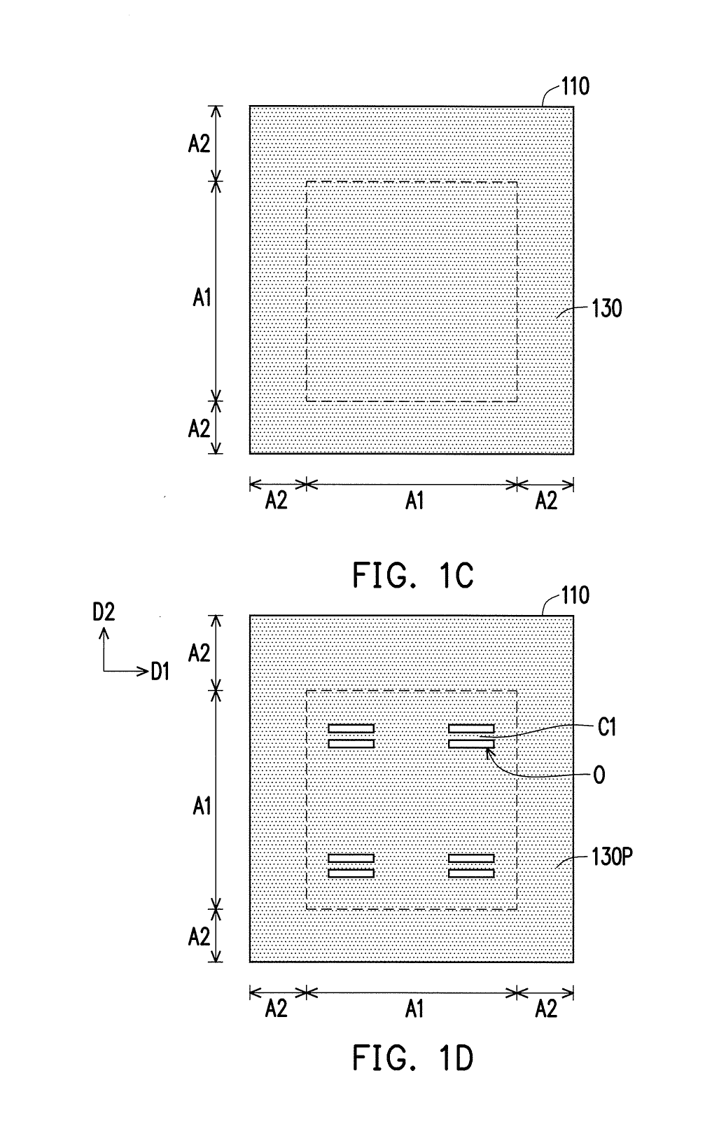

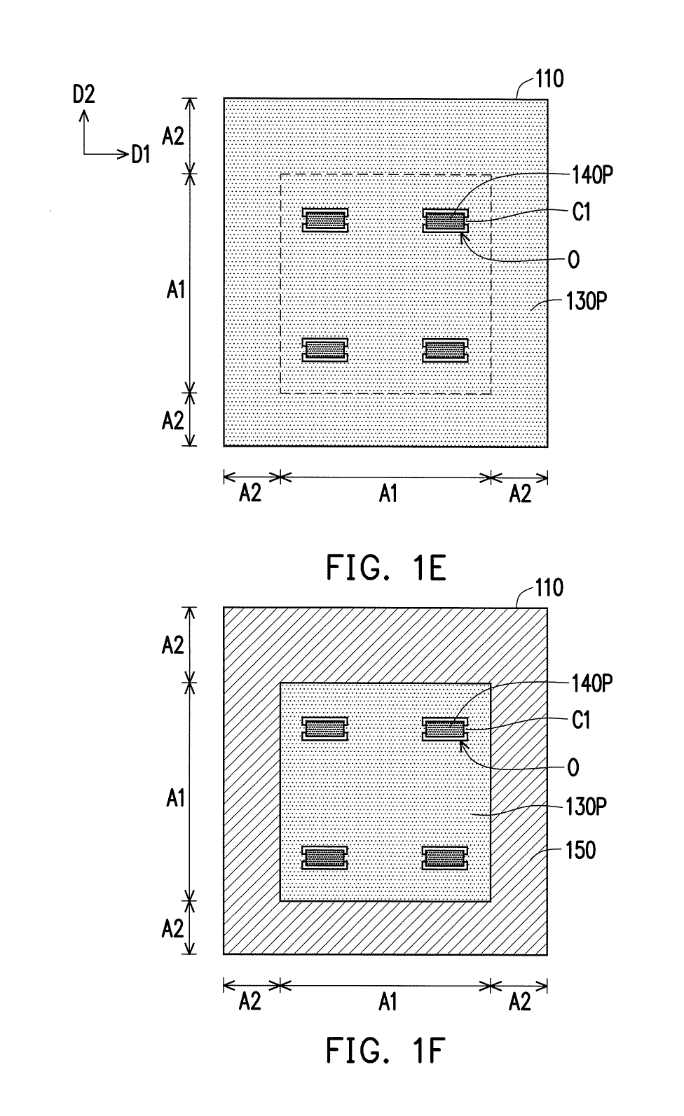

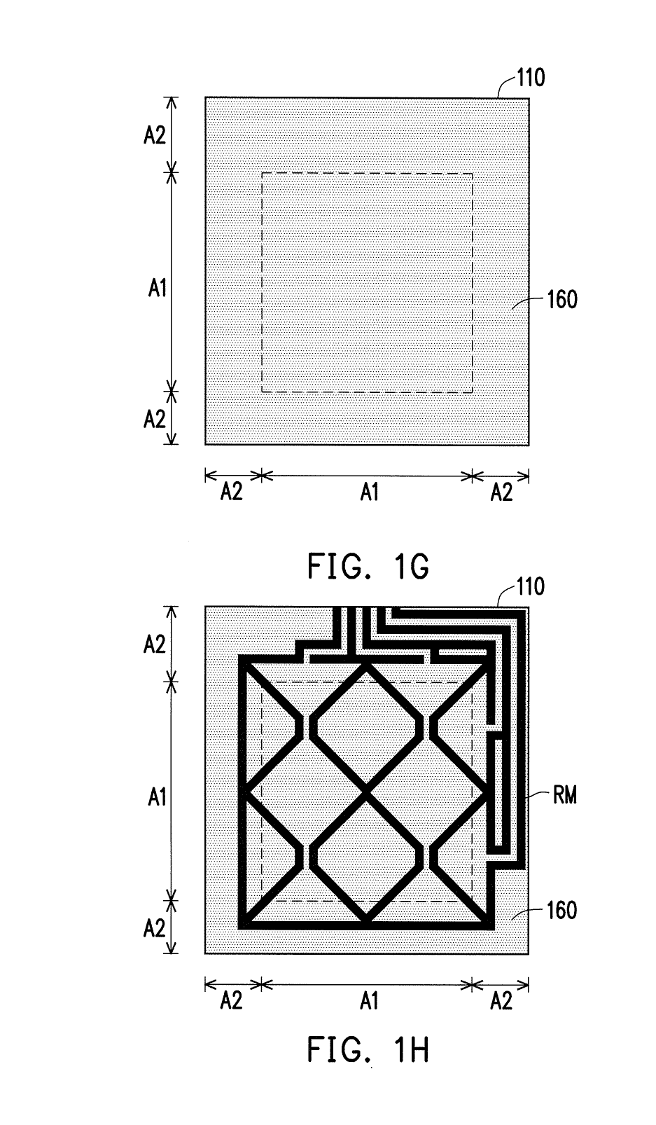

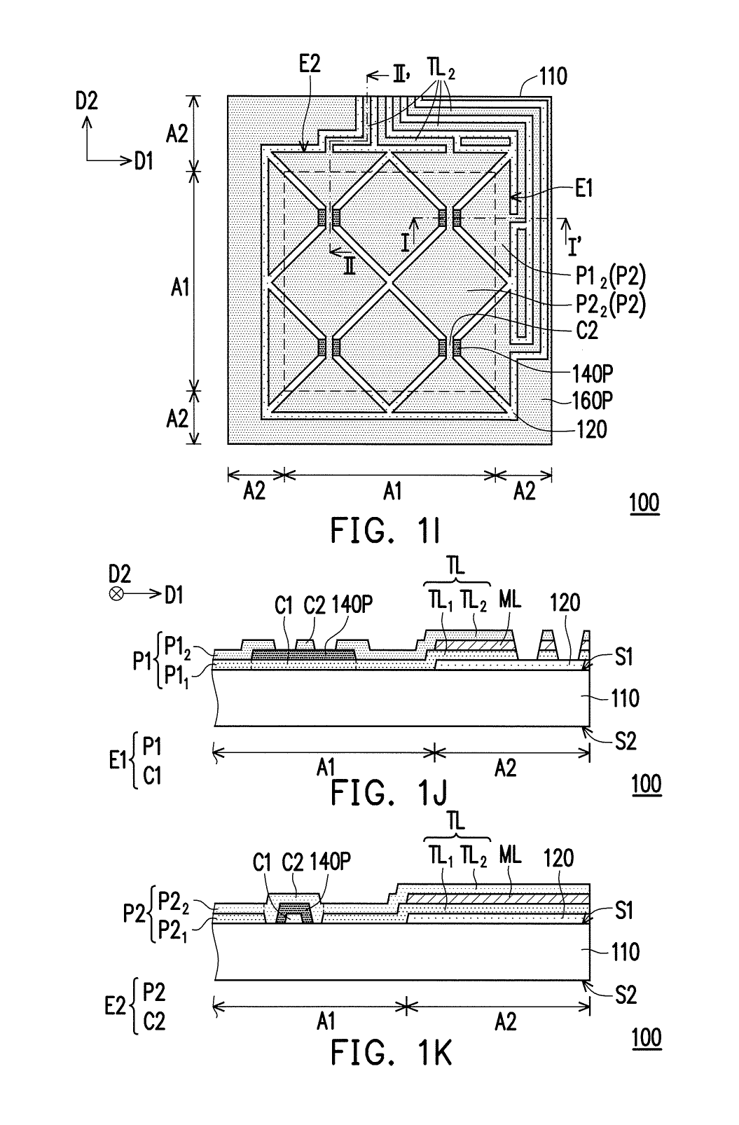

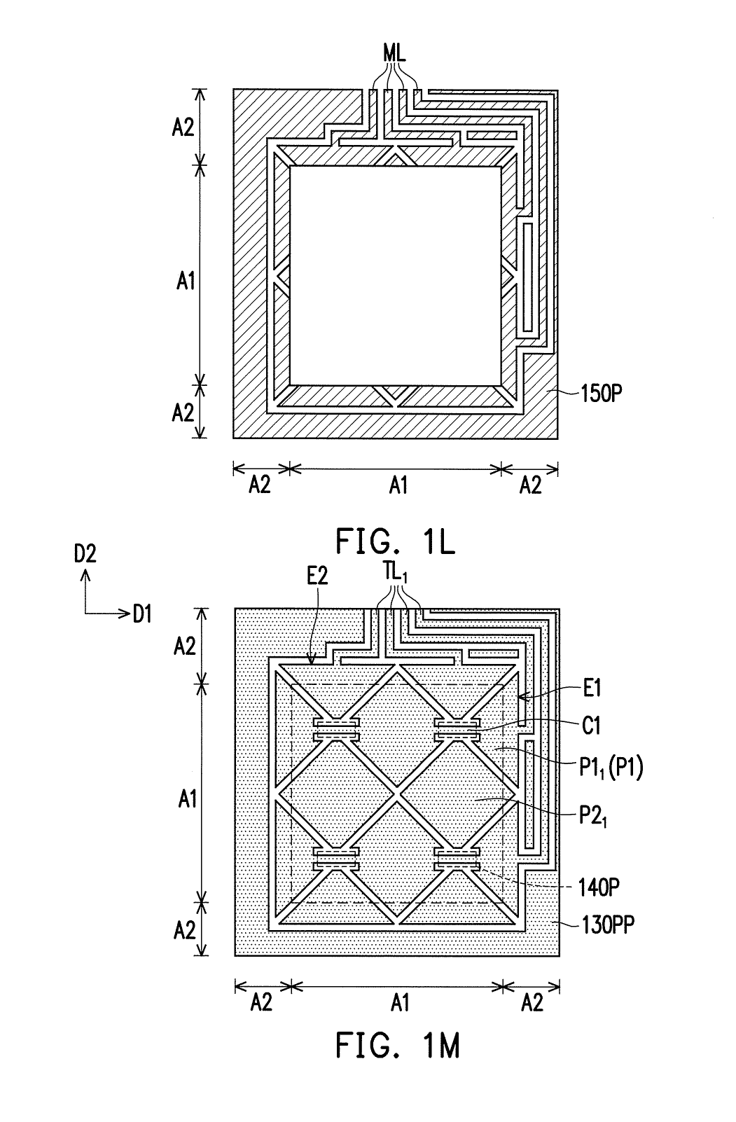

FIG. 1A to FIG. 1I are top schematic diagrams of a manufacturing process of a touch panel according to the first embodiment of the invention. FIG. 1J and FIG. 1K are respectively cross-sectional schematic diagrams along line I-I′ and line II-II′ in FIG. 1I. FIG. 1L is a top schematic diagram of the metal layer in FIG. 1I. FIG. 1M is a top schematic diagram of the first transparent conductive layer in FIG. 1I.

Referring to FIG. 1A, a substrate 110 is provided. The substrate 110 can be a high-mechanical strength substrate such as a glass substrate, but is not limited thereto. The substrate 110 has an active region A1 and a periphery region A2. The periphery region A2 is connected to the active region A1. In the embodiment, the periphery region A2 surrounds the active region A1 (the dashed line in FIG. 1A shows the junction of the active region A1 and the periphery region A2), but is not limited thereto.

Referring to FIG. 1B, a decoration layer 120 is formed on the substrate 110. The decoration layer 120 covers the periphery region A2 and exposes the active region A1. The material of the decoration layer 120 includes a light-resisting material. The light-resisting material is defined as a material for which loss of light occurs when light passes through the interface of the material. Therefore, the decoration layer 120 can shield devices in the periphery region A2 not to be seen, such as subsequently-formed metal wirings ML or other circuits not shown.

Referring to FIG. 1C, a first transparent conductive material layer 130 is formed on the substrate 110. The first transparent conductive material layer 130 covers the active region A1 and the periphery region A2. The material of the first transparent conductive material layer 130 is a transparent conductive material such as metal oxide, but is not limited thereto. The metal oxide can include indium tin oxide, indium zinc oxide, aluminum tin oxide, aluminum zinc oxide, or indium germanium zinc oxide.

Referring to FIG. 1D, the first transparent conductive material layer 130 is patterned to form a first transparent conductive layer 130P having a plurality of openings O. The method of patterning the first transparent conductive material layer 130 can be a lithography etching process or a laser removal process. In the embodiment, the method of patterning the first transparent conductive material layer 130 is, for instance, a laser removal process. Since the laser removal process does not require a photomask and an etchant, the manufacturing cost of the touch panel 100 can be further reduced.

In the first transparent conductive layer 130P, the openings O define a plurality of first connecting portions C1. Specifically, each of the openings O of the embodiment is a strip opening respectively. Each of the strip openings is extended along a first direction D1 respectively, and two adjacent strip openings in a second direction D2 define one of the first connecting portions C1. The second direction D2 and the first direction D1 are intersected with each other, and are, for instance, perpendicular to each other, but are not limited thereto.

Referring to FIG. 1E, a patterned insulating layer 140P is formed on the substrate 110. The patterned insulating layer 140P covers the openings O and the first connecting portions C1. In the embodiment, the patterned insulating layer 140P exposes two opposite ends of each of the first connecting portions C1 in the first direction D1 and exposes a partial region of each of the openings O, but is not limited thereto. The material of the patterned insulating layer 140P is, for instance, silicon oxide, silicon nitride, or an organic insulating material, but is not limited thereto.

Referring to FIG. 1F, a metal layer 150 is formed on the substrate 110. The metal layer 150 covers the periphery region A2 and exposes the active region A1. The material of the metal layer 150 can include, for instance, silver (Ag), aluminum (Al), copper (Cu), molybdenum (Mo), neodymium (Nd), other metal materials having good conductivity, or an alloy of at least two of the above. The metal layer 150 can be a single-layer or multi-layer conductive structure formed by stacking the metal material.

Referring to FIG. 1G, a second transparent conductive material layer 160 is formed on the substrate 110. The second transparent conductive material layer 160 covers the active region A1 and the periphery region A2. The material of the second transparent conductive material layer 160 is a transparent conductive material such as metal oxide, but is not limited thereto. The metal oxide can include indium tin oxide, indium zinc oxide, aluminum tin oxide, aluminum zinc oxide, or indium germanium zinc oxide.

Referring to FIG. 1H to FIG. 1M, the second transparent conductive material layer 160, the first transparent conductive layer 130P, and the metal layer 150 are patterned together to foil i a plurality of first electrode pads P1, a plurality of second electrode pads P2, a plurality of second connecting portions C2, a plurality of transparent wirings TL, and a plurality of metal wirings ML. As a result, the manufacture of the touch panel 100 is preliminarily completed.

In the embodiment, the method of patterning the second transparent conductive material layer 160, the first transparent conductive layer 130P, and the metal layer 150 can include removing the second transparent conductive material layer 160, the first transparent conductive layer 130P, and the metal layer 150 at the bottom of a thick line RM shown in FIG. 1H via a lithography process (such as lithography and etching steps). The portions of patterned second transparent conductive layer 160P (refer to FIG. 1I), metal layer 150P (refer to FIG. 1L), and first transparent conductive layer 130PP (refer to FIG. 1M) corresponding to the thick line RM are removed. However, since the patterned insulating layer 140P has the function of an etching stop, the patterned insulating layer 140P can prevent erosion to the first connecting portions C1 located below the patterned insulating layer 140P by an etchant, so as to ensure the integrity of the pattern of the first connecting portions C1 (refer to FIG. 1M).

Referring to FIG. 1I to FIG. 1M, the touch panel 100 includes a substrate 110, a plurality of first electrodes E1, a plurality of second electrodes E2, a patterned insulating layer 140P, a plurality of metal wirings ML, and a plurality of transparent wirings TL, and the touch panel 100 can optionally include a decoration layer 120. The substrate 110 has an inner surface S1 and an outer surface S2 opposite to the inner surface S1. In the embodiment, the inner surface S1 is a device arrangement surface, wherein the first electrodes E1, the second electrodes E2, the patterned insulating layer 140P, the metal wirings ML, the transparent wirings TL, and the decoration layer 120 are disposed on the inner surface S1 of the substrate 110. The outer surface S2 is a touch operation surface. That is, a conductive object can perform a touch operation by touching the outer surface S2.

Each of the first electrodes E1 includes a plurality of first electrode pads P1 and at least one first connecting portion C1, and each first connecting portion C1 connects the first electrode pads P1 in series along the first direction D1. In the embodiment, each of the first electrodes E1 includes a plurality of first connecting portions C1, and each of the first connecting portions C1 connects two adjacent first electrode pads P1 in series along the first direction D1. The second electrodes E2 and the first electrodes E1 are disposed in a staggered manner. Each of the second electrodes E2 includes a plurality of second electrode pads P2 and a plurality of second connecting portions C2. Each of the second connecting portions C2 connects two adjacent second electrode pads P2 in series along the second direction D2. The patterned insulating layer 140P is disposed on the substrate 110 and covers the first connecting portions C1, wherein each of the second connecting portions C2 is disposed across the patterned insulating layer 140P to connect two adjacent second electrode pads P2 in series.

The metal wirings ML are disposed on the substrate 110 and are disposed, for instance, on the decoration layer 120 in the periphery region A2. Each of the metal wirings ML is electrically connected to one of the first electrodes E1 or one of the second electrodes E2. The transparent wirings TL are disposed on the substrate 110 and are disposed, for instance, on the decoration layer 120 in the periphery region A2. It should be mentioned that, the metal wirings ML or the transparent wirings TL are not limited to be electrically connected to one of the first electrodes E1 or one of the second electrodes E2 on a single side. In another embodiment, the metal wirings ML or the transparent wirings TL can also be electrically connected at two ends of one of the first electrodes E1 or one of the second electrodes E2 to reduce the impedance of the signal transmission path of the first electrode E1 or the second electrode E2. Each of the transparent wirings TL is electrically connected to one of the first electrodes E1 or one of the second electrodes E2, wherein each of the transparent wirings TL is electrically connected to one of the metal wirings ML respectively and overlapped with the one of the metal wirings ML.

More specifically, each of the first electrode pads P1 includes a first sub-layer P1₁ and a second sub-layer P1₂, and the first sub-layer P1₁ is located between the second sub-layer P1₂ and the substrate 110. Each of the second electrode pads P2 includes a first sub-layer P2₁ and a second sub-layer P2₂, and the first sub-layer P2₁ is located between the second sub-layer P2₂ and the substrate 110. Each of the transparent wirings TL includes a first sub-layer TL₁ and a second sub-layer TL₂, and the first sub-layer TL₁ is located between the second sub-layer TL₂ and the substrate 110. The first sub-layers P1₁, P2₁, and TL₁ and the first connecting portions C1 belong to the first transparent conductive material layer 130 (refer to FIG. 1C). The second sub-layers P1₂, P2₂, and TL₂ and the second connecting portions C2 belong to the second transparent conductive material layer 160 (refer to FIG. 1G).

In each of the first electrodes E1, although the second sub-layers P1₂ of the first electrode pads P1 are structurally separated from one another, since the second sub-layer P1₂ is in contact with the first sub-layer P1₁ and the first connecting portions C1 connect two adjacent first sub-layers P1₁ in series along the first direction D1, the second sub-layers P1₂ of the first electrode pads P1 in each of the first electrodes E1 are electrically connected to one another. In each of the second electrodes E2, although the first sub-layers P2₁ of the second electrode pads P2 are structurally separated from one another, since the first sub-layer P2₁ is in contact with the second sub-layer P2₂ and the second connecting portions C2 connect two adjacent second sub-layers P2₂ in series along the second direction D2, the first sub-layers P2₁ of the second electrode pads P2 in each of the second electrodes E2 are electrically connected to one another.

In the embodiment, the first transparent conductive material layer 130 (refer to FIG. 1C), the metal layer 150 (refer to FIG. 1F), and the second transparent conductive material layer 160 (refer to FIG. 1G) are disposed on the substrate 110 in order. Therefore, each of the metal wirings ML is located between the first sub-layer TL₁ and the second sub-layer TL₂ of one of the transparent wirings TL, wherein the second sub-layer TL₂ covers the metal wirings ML and can prevent oxidation of the metal wirings ML. However, the invention is not limited thereto. In another embodiment, the order of manufacture of the metal layer 150 and the second transparent conductive material layer 160 can be reversed. Therefore, the second sub-layer TL₂ of each of the transparent wirings TL is located between one of the metal wirings ML and the first sub-layer TL₁. In yet another embodiment, the order of manufacture of the metal layer 150 and the first transparent conductive material layer 130 can be reversed. Therefore, the first sub-layer TL₁ of each of the transparent wirings TL is located between one of the metal wirings ML and the second sub-layer TL₂.

The impedance of the signal transmission path can be reduced via the metal wirings ML such that the touch panel 100 can have good touch sensitivity. Moreover, in the manufacturing method of the touch panel 100, the openings O are formed on the first transparent conductive material layer 130 to define the first connecting portions C1, and then the second transparent conductive material layer 160 and the first transparent conductive layer 130P are patterned together to form the first electrode pads P1, the second electrode pads P2, the second connecting portions C2, and the transparent wirings TL. In the embodiment, the extra step of patterning the metal layer ML can be omitted by patterning the second transparent conductive material layer 160, the first transparent conductive layer 130P, and the metal layer 150 together. Therefore, the manufacturing method of the touch panel 100 can reduce the quantity of lithography processes and simplify the manufacturing process of the touch panel 100.

It should be mentioned that, FIG. 1A to FIG. 1I only show one manufacturing process of the touch panel 100. However, those skilled in the art can adjust the pattern of each of the film layers and the stacking order between the film layers, add other film layers, or omit a portion of the film layers based on different design requirements without departing from the spirit of the invention.

For instance, after the step of FIG. 1I, a protective layer (not shown) can be further formed. The protective layer can cover the active region A1 and the periphery region A2 and expose the region of the transparent wirings TL to be bonded with a flexible circuit board (not shown). Alternatively, the protective layer can only cover the intersection of the first electrodes E1 and the second electrodes E2 and the transparent wirings TL and expose the region of the transparent wirings TL to be bonded with a flexible circuit board (not shown).

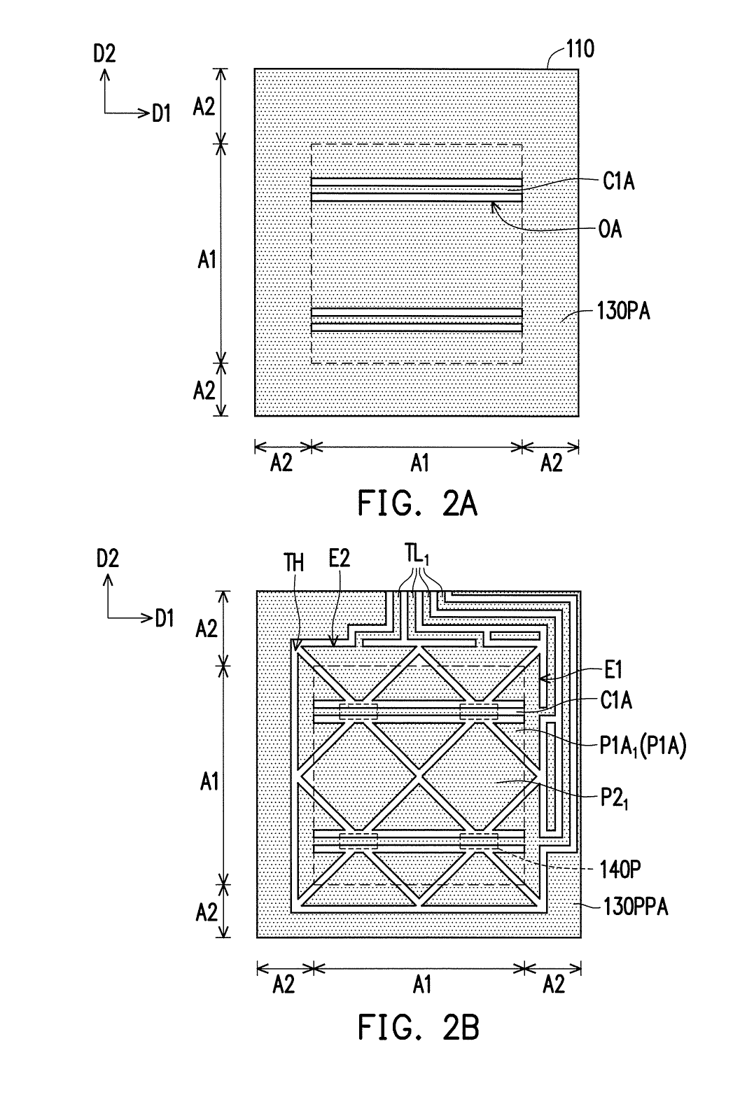

In the following, FIG. 2A to FIG. 8F explain other manufacturing processes of the touch panel, wherein the same or similar devices are labeled with the same or similar reference numerals and are not repeated herein. FIG. 2A is a top schematic diagram of another embodiment of the first transparent conductive layer in FIG. 1D. FIG. 2B is a top schematic diagram of the first transparent conductive layer of FIG. 2A after the patterning process of FIG. 1H. Referring to FIG. 2A, a plurality of openings OA can be formed on a first transparent conductive layer 130PA, and two adjacent openings OA define a plurality of first connecting portions C1A. Each of the openings OA can, for instance, be extended to the junction of the active region A1 and the periphery region A2 along the first direction D1, but is not limited thereto. Then, the manufacture of the touch panel can be completed via the steps of FIG. 1E to FIG. 1H. Referring to FIG. 2B, in a first transparent conductive layer 130PPA after the patterning process of FIG. 1H, each of the openings OA is disposed across (or passes through) at least one first electrode pad P1A of one of the first electrodes E1 respectively, and is, for instance, disposed across (or passes through) a first sub-layer P1A₁ of the at least one first electrode pad P1A. In this structure, the quantity of the first connecting portion C1A of each of the first electrodes E1 is one, and the first connecting portion C1A connects the first sub-layers P1A₁ of the first electrode pads P1A at two opposite ends.

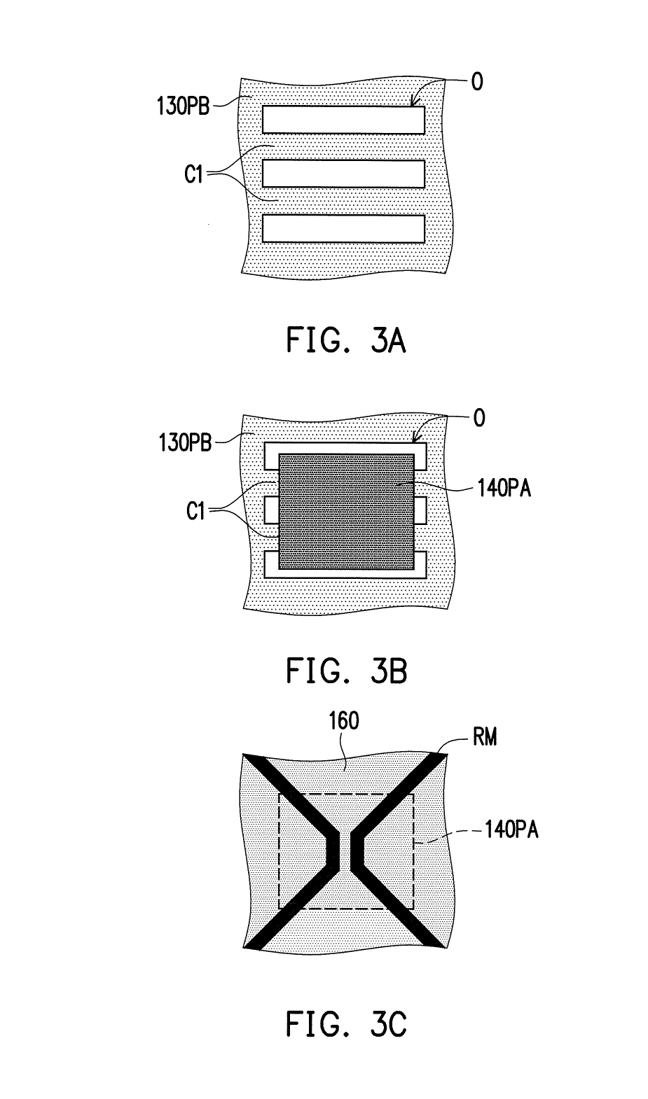

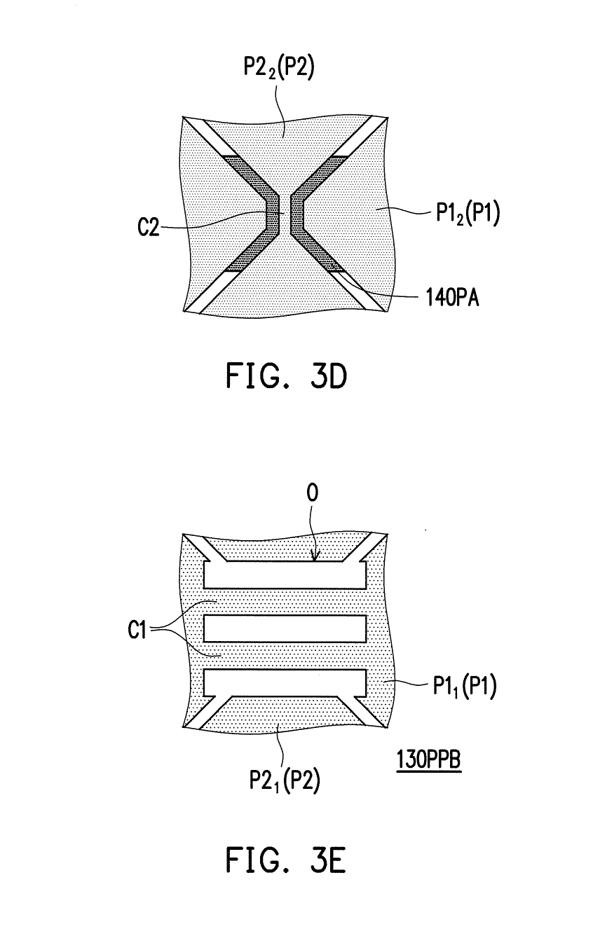

FIG. 3A to FIG. 3E are partial top schematic diagrams of a manufacturing process of a touch panel according to the second embodiment of the invention, wherein FIG. 3A to FIG. 3D respectively correspond to the steps of FIG. 1D, FIG. 1E, FIG. 1H, and FIG. 1I, and FIG. 3E shows a first transparent conductive layer 130PPB after the patterning process of FIG. 3D. FIG. 3A to FIG. 3E omit the steps corresponding to FIG. 1F and FIG. 1G. The relevant content is as described above and is not repeated herein.

Referring to FIG. 3A, three strips of openings O disposed adjacent to one another can be formed on a first transparent conductive layer 130PB, and two adjacent openings O define one strip of first connecting portion C1. Referring to FIG. 3B, a patterned insulating layer 140PA covers the openings O and the first connecting portions C1. Referring to FIG. 3C to FIG. 3E, the second transparent conductive material layer 160, the first transparent conductive layer 130PB, and the metal layer (not shown) are removed along the thick line RM to form the first electrode pads P1, the second electrode pads P2, the second connecting portions C2, the transparent wirings (not shown), and the metal wirings (not shown). In the embodiment, the first sub-layers P1₁ of two adjacent first electrode pads P1 are connected in series by two strips of first connecting portions C1.

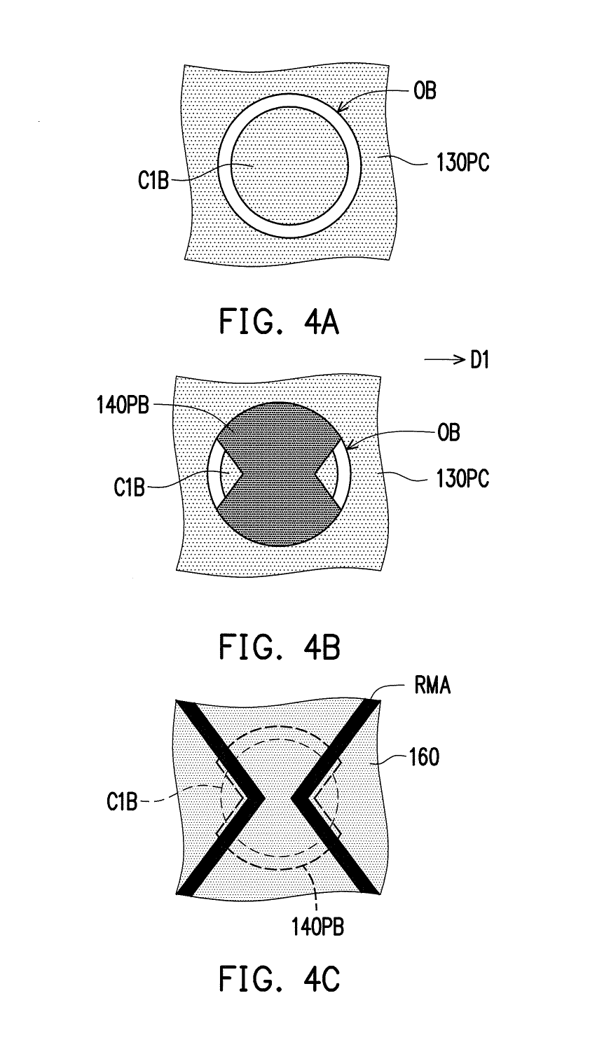

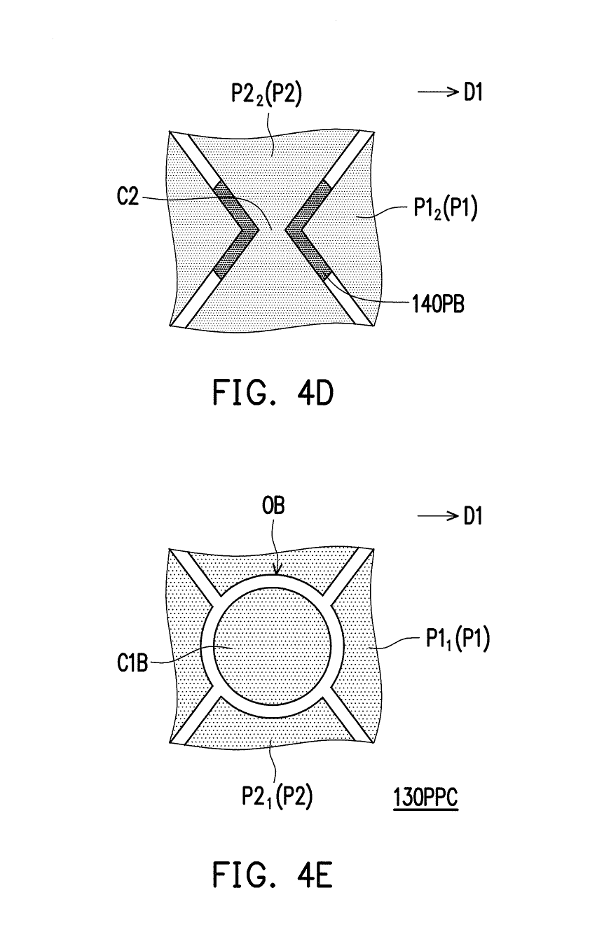

FIG. 4A to FIG. 4E are partial top schematic diagrams of a manufacturing process of a touch panel according to the third embodiment of the invention, wherein FIG. 4A to FIG. 4D respectively correspond to the steps of FIG. 1D, FIG. 1E, FIG. 1H, and FIG. 1I, and FIG. 4E shows a first transparent conductive layer 130PPC after the patterning process of FIG. 4D. FIG. 4A to FIG. 4E omit the steps corresponding to FIG. 1F and FIG. 1G. The relevant content is as described above and is not repeated herein.

Referring to FIG. 4A, a plurality of annular openings OB can be formed on a first transparent conductive layer 130PC, and each of the annular openings OB defines one of first connecting portions C1B. The annular openings OB are, for instance, circular, but are not limited thereto. Referring to FIG. 4B, a patterned insulating layer 140PB covers the openings OB and the first connecting portions C1B. In the embodiment, the patterned insulating layer 140PB exposes two opposite ends of each of the first connecting portions C1B in the first direction D1. Referring to FIG. 4C to FIG. 4E, the second transparent conductive material layer 160, the first transparent conductive layer 130PC, and the metal layer (not shown) are removed along a thick line RMA to form the first electrode pads P1, the second electrode pads P2, the second connecting portions C2, the transparent wirings (not shown), and the metal wirings (not shown).

Although the second sub-layers P1₂ of the adjacent first electrode pads P1 in the first direction D1 are structurally separated from one another and the first sub-layers P1₁ of the adjacent first electrode pads P1 in the first direction D1 and the first connecting portions C1B are structurally separated from one another, since the first sub-layer P1₁ and the second sub-layer P1₂ of each of the first electrode pads P1 are in contact with each other and the second sub-layer P1₂ is further in contact with the corresponding first connecting portion C1B, the first electrode pads P1 and the first connecting portions C1B can conduct along the first direction D1.

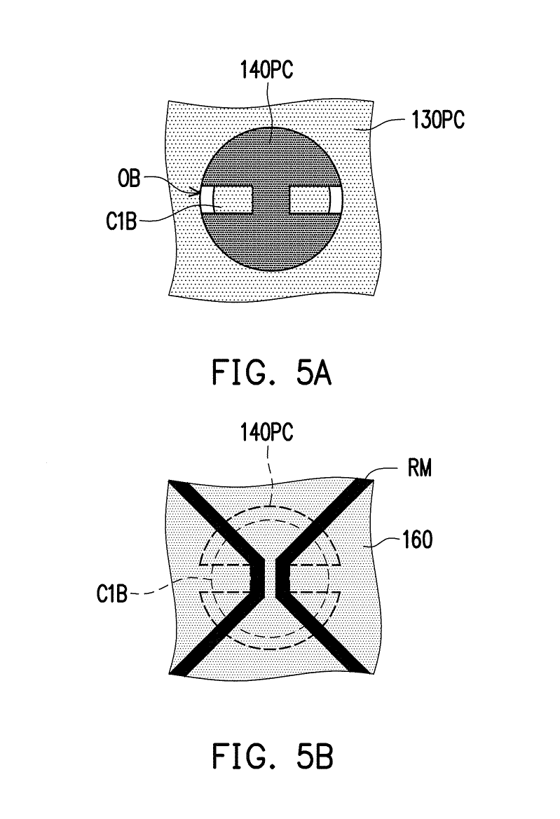

In the structure of the annular openings, the shapes of the first connecting portions, the patterned insulating layer, and the thick line defining the location of patterning can be changed as needed. In the following, FIG. 5A to FIG. 7E provide other embodiments of the annular openings. FIG. 5A and FIG. 5B are partial top schematic diagrams of a manufacturing process of a touch panel according to the fourth embodiment of the invention, wherein FIG. 5A and FIG. 5B respectively correspond to the steps of FIG. 1E and FIG. 1H. Referring to FIG. 5A and FIG. 5B, in the structure of the annular openings OB, the patterned insulating layer 140PB of FIG. 4B can be replaced by a patterned insulating layer 140PC of FIG. 5A, and the thick line RMA defining the location of patterning in FIG. 4C can be replaced by the thick line RM of FIG. 5B.

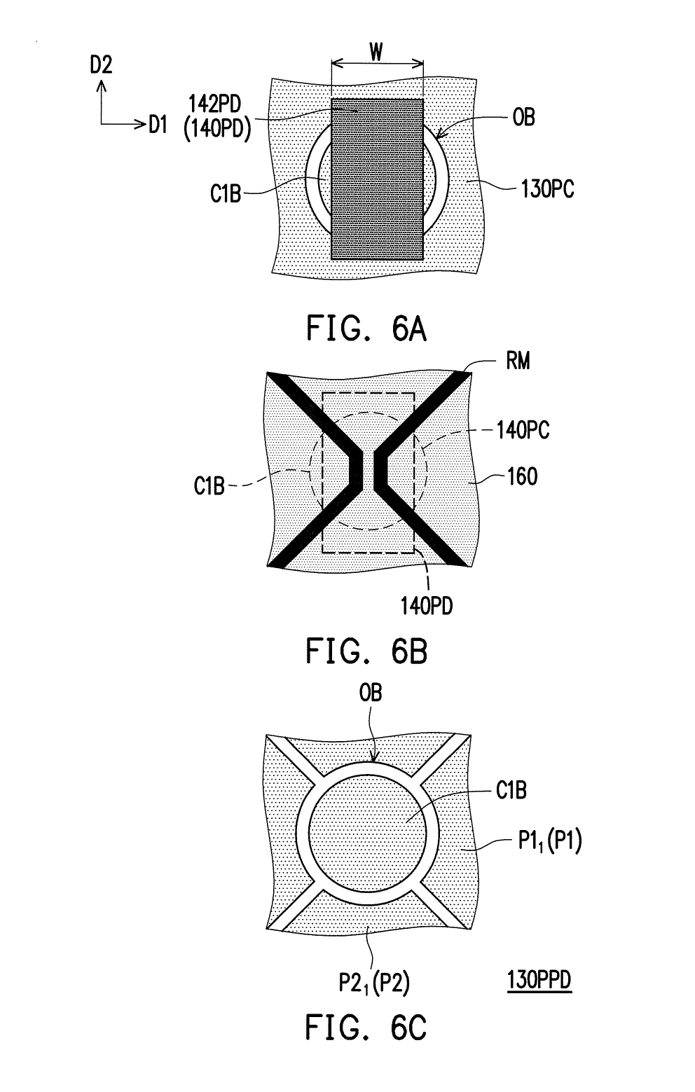

FIG. 6A to FIG. 6C are partial top schematic diagrams of a manufacturing process of a touch panel according to the fifth embodiment of the invention, wherein FIG. 6A and FIG. 6B respectively correspond to the steps of FIG. 1E and FIG. 1H, and FIG. 6C shows a first transparent conductive layer 130PPD after the patterning process of FIG. 6B. Referring to FIG. 6A to FIG. 6C, in the structure of the annular openings OB, the patterned insulating layer 140PB of FIG. 4B can be replaced by a patterned insulating layer 140PD of FIG. 6A. The patterned insulating layer 140PD can include a plurality of strip insulating patterns 142PD (one is schematically shown in FIG. 6A). Each of the strip insulating patterns P142PD can be extended along the second direction D2, wherein a width W of each of the strip insulating patterns P142PD in the first direction D1 determines whether the first connecting portions C1B are eroded by the etchant in a subsequent patterning process. In the embodiment, the strip insulating patterns 142PD can completely shield the first connecting portions C1B through which the thick line RM passes.

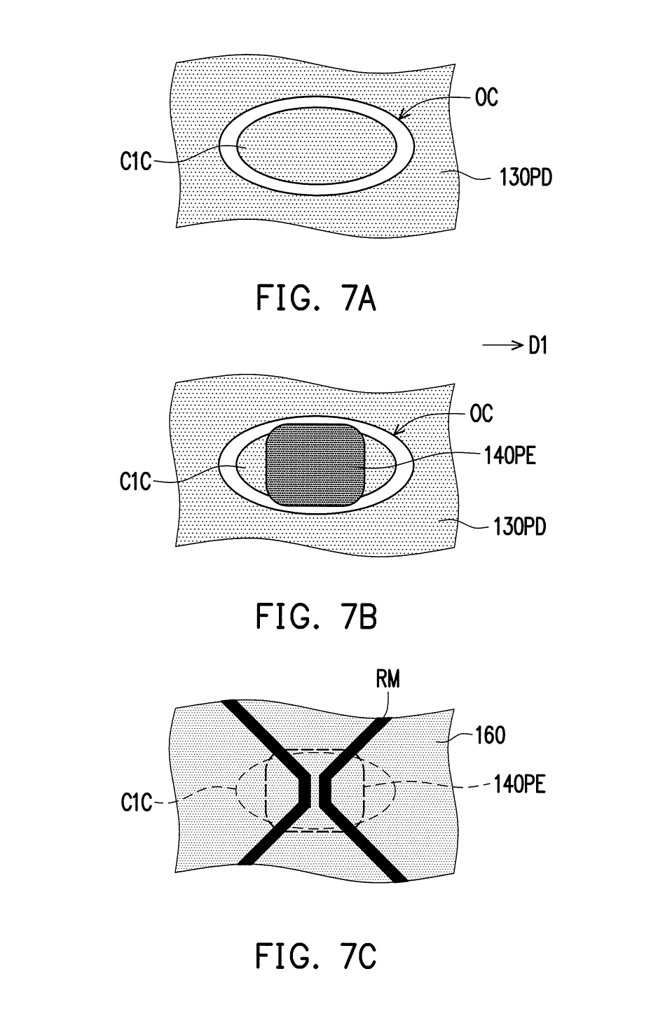

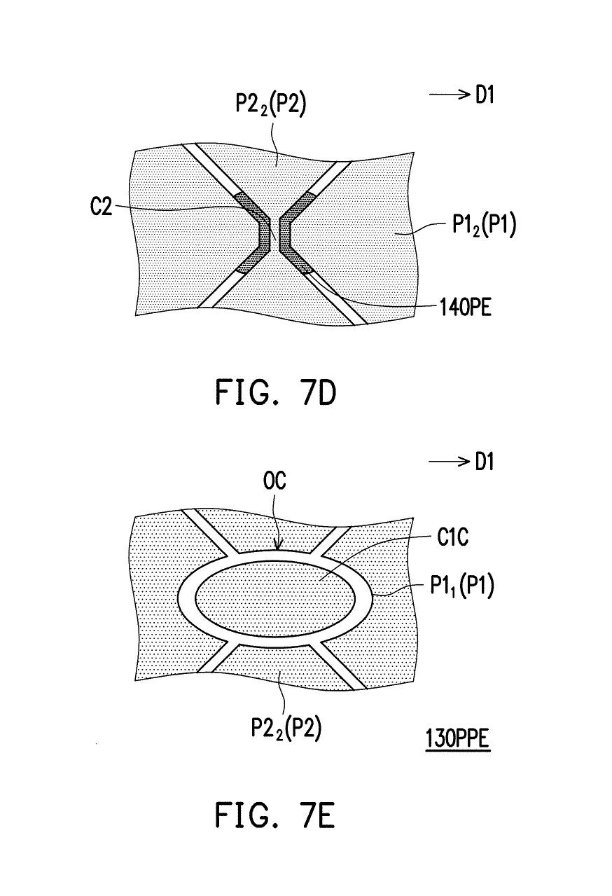

FIG. 7A to FIG. 7E are partial top schematic diagrams of a manufacturing process of a touch panel according to the sixth embodiment of the invention, wherein FIG. 7A to FIG. 7D respectively correspond to the steps of FIG. 1D, FIG. 1E, FIG. 1H, and FIG. 1I, and FIG. 7E shows a first transparent conductive layer 130PPE after the patterning process of FIG. 7D. FIG. 7A to FIG. 7E omit the steps corresponding to FIG. 1F and FIG. 1G. The relevant content is as described above and is not repeated herein.

Referring to FIG. 7A, a plurality of annular openings OC can be &limed on a first transparent conductive layer 130PD, and each of the annular openings OC defines one of first connecting portions C1C. The annular openings OC are, for instance, elliptical, but are not limited thereto. Referring to FIG. 7B, a patterned insulating layer 140PE covers the openings OC and the first connecting portions C1C. In the embodiment, the patterned insulating layer 140PE exposes two opposite ends of each of the first connecting portions C1C in the first direction D1. Referring to FIG. 7C to FIG. 7E, the second transparent conductive material layer 160, the first transparent conductive layer 130PD, and the metal layer (not shown) are removed along the thick line RM to form the first electrode pads P1, the second electrode pads P2, the second connecting portions C2, the transparent wirings (not shown), and the metal wirings (not shown).

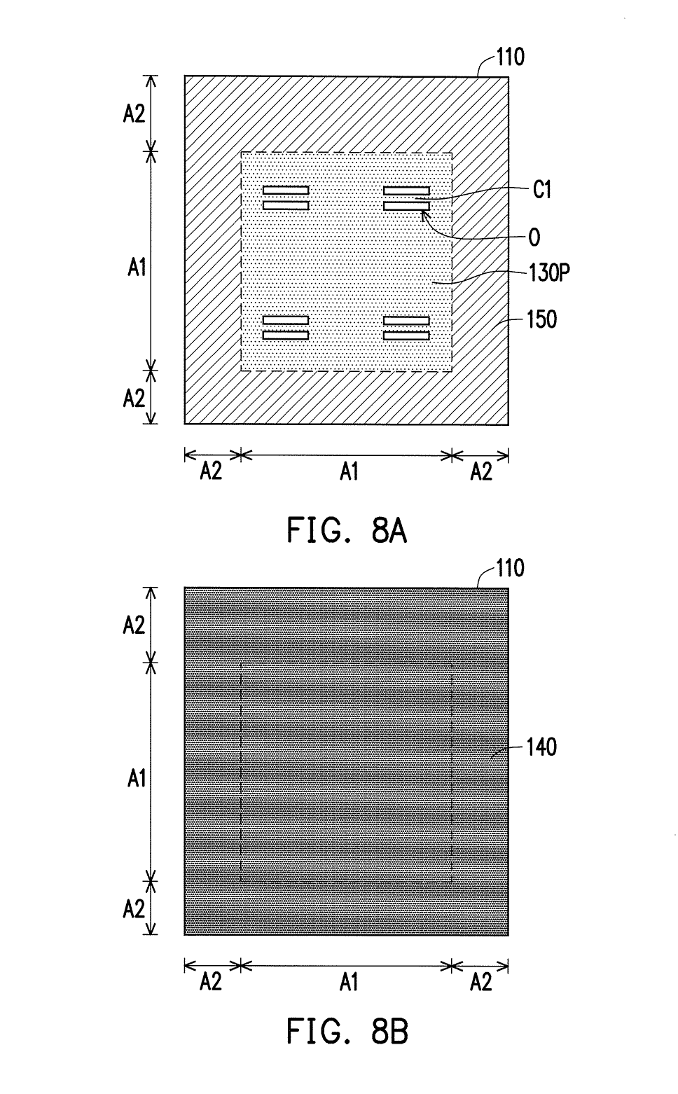

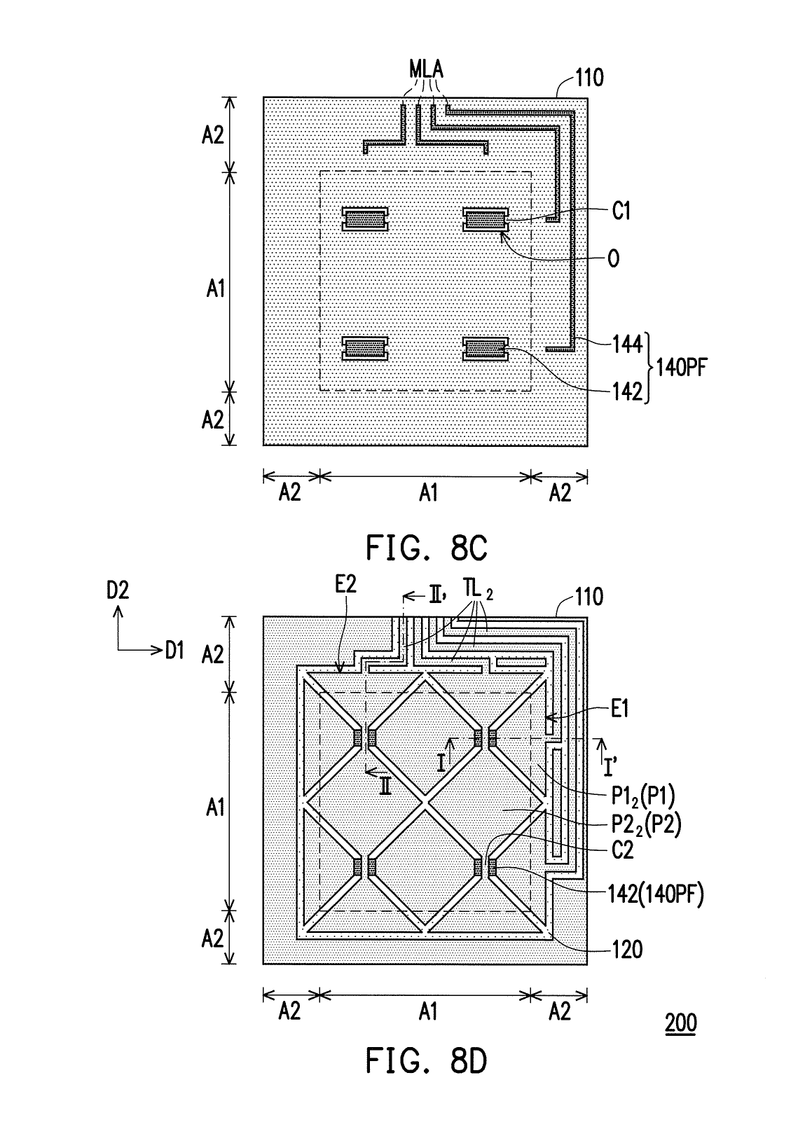

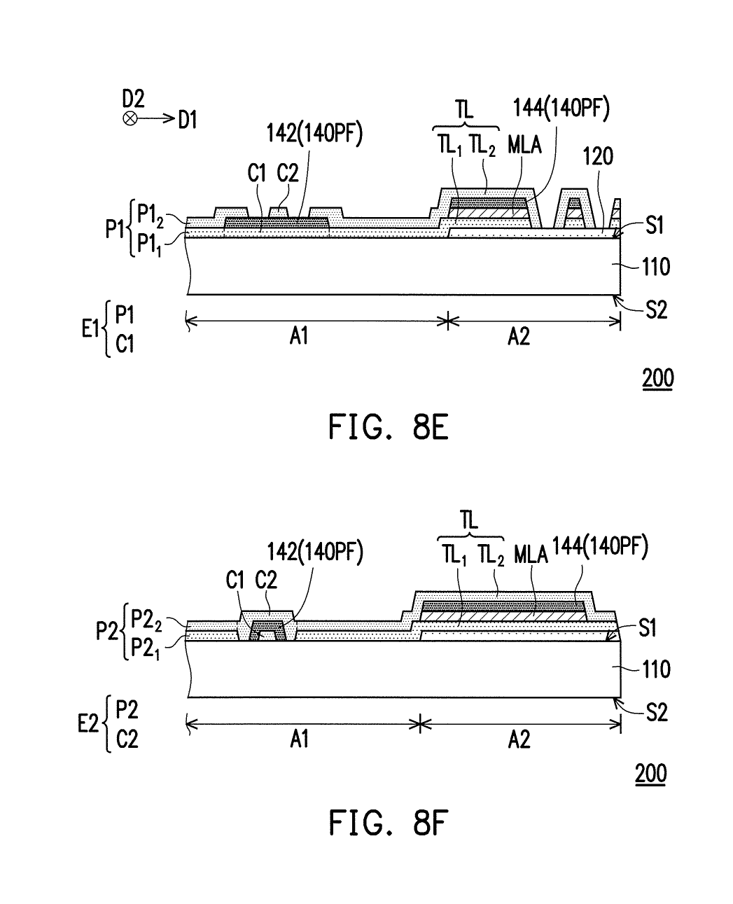

In the above embodiments, the metal layer is patterned at the same time that the second transparent conductive layer and the first transparent conductive layer are patterned, but the invention is not limited thereto. FIG. 8A to FIG. 8D are top schematic diagrams of a manufacturing process of a touch panel according to the seventh embodiment of the invention. FIG. 8E and FIG. 8F are respectively cross-sectional schematic diagrams along line I-I′ and line II-II′ in FIG. 8D.

Referring to FIG. 8A and FIG. 8B, after the step of FIG. 1D, the metal layer 150 can be formed on the first transparent conductive layer 130P first, and then the insulating layer 140 is formed on the metal layer 150, the first transparent conductive layer 130P exposed by the metal layer 150, and the substrate 110 exposed by the openings O. In the embodiment, the materials of the insulating layer 140 and the metal layer 150 can respectively be light-sensitive materials. For instance, the material of the metal layer 150 can be silver paste, and the method of forming the metal layer 150 can be printing, but are not limited thereto.

Referring to FIG. 8C, the insulating layer 140 and the metal layer 150 are patterned to form a patterned insulating layer 140PF and metal wirings MLA. Since the materials of the insulating layer 140 and the metal layer 150 are both light-sensitive materials, the insulating layer 140 and the metal layer 150 can be patterned together via steps such as exposure and development.

The patterned insulating layer 140PF can include a plurality of insulating blocks 142 and a plurality of insulating strips 144, wherein the insulating blocks 142 are located in the active region A1 and cover the openings O and the first connecting portions C1, and the insulating strips 144 are located in the periphery region A2 and cover the metal wirings MLA. Then, the steps of FIG. 1G and FIG. 1H can be performed to form a touch panel 200 of FIG. 8D to FIG. 8F.

Referring to FIG. 8D to FIG. 8F, the patterned insulating layer 140PF (insulating strips 144) of the embodiment is further located between the second sub-layer TL₂ of the transparent wirings TL and the metal wirings MLA, and the first sub-layer TL₁ and the second sub-layer TL₂ of each of the transparent wirings TL are in contact at the end of the transparent wirings TL away from the first electrodes E1 and the second electrodes E2 so as to bond with a flexible circuit board not shown.

Based on the above, the touch panel of the invention reduces the impedance of the signal transmission path via metal wirings, and therefore the touch panel can have good touch sensitivity. Moreover, in the manufacturing method of the touch panel, openings are formed on the first transparent conductive layer to define the first connecting portions, and then the second transparent conductive layer and the first transparent conductive layer are patterned together to form the first electrode pads, the second electrode pads, the second connecting portions, and the transparent wirings. Therefore, the manufacturing method of the touch panel of the invention can reduce the quantity of lithography processes. In an embodiment, the second transparent conductive layer, the first transparent conductive layer, and the metal layer used to manufacture the metal wirings can also be patterned together, or the metal layer and the insulating layer used to manufacture the patterned insulating layer are patterned together to omit the extra step of patterning the metal layer.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A manufacturing method of a touch panel, comprising:
forming a first transparent conductive material layer on a substrate;
patterning the first transparent conductive material layer to form a first transparent conductive layer having a plurality of openings, wherein the openings define a plurality of first connecting portions;
forming a patterned insulating layer on the substrate, wherein the patterned insulating layer covers the openings and the first connecting portions;
forming a plurality of metal wirings on the substrate;
forming a second transparent conductive material layer on the substrate; and
patterning the second transparent conductive material layer and the first transparent conductive layer to form a plurality of first electrode pads, a plurality of second electrode pads, a plurality of second connecting portions, and a plurality of transparent wirings, wherein the first connecting portions connect the first electrode pads in series along a first direction to form a plurality of first electrodes, the second connecting portions connect the second electrode pads in series along a second direction to form a plurality of second electrodes, the second electrodes are electrically insulated from the first electrodes via the patterned insulating layer, and each of the transparent wirings connects one of the first electrodes or one of the second electrodes respectively, wherein each of the transparent wirings is electrically connected to one of the metal wirings respectively and overlapped with the one of the metal wirings.

2. The manufacturing method of the touch panel of claim 1, wherein a method of patterning the first transparent conductive material layer is a lithography etching process or a laser removal process.

3. The manufacturing method of the touch panel of claim 1, wherein each of the openings is a strip opening respectively, each of the strip openings is extended along the first direction respectively, and two adjacent strip openings in the second direction define one of the first connecting portions.

4. The manufacturing method of the touch panel of claim 3, wherein each of the openings is disposed across at least one of the first electrode pads of one of the first electrodes respectively.

5. The manufacturing method of the touch panel of claim 1, wherein each of the openings is an annular opening respectively, and each of the annular openings defines one of the first connecting portions.

6. The manufacturing method of the touch panel of claim 5, wherein the patterned insulating layer exposes two opposite ends of each of the first connecting portions in the first direction.

7. The manufacturing method of the touch panel of claim 1, wherein a method of foil ling the metal wirings comprises:
forming a metal layer on the substrate; and
patterning the second transparent conductive material layer, the first transparent conductive layer, and the metal layer together to form the first electrode pads, the second electrode pads, the second connecting portions, the transparent wirings, and the metal wirings.

8. The manufacturing method of the touch panel of claim 1, wherein a method of forming the metal wirings and the patterned insulating layer comprises:
forming a metal layer on the first transparent conductive layer;
forming an insulating layer on the metal layer, the first transparent conductive layer exposed by the metal layer, and the substrate exposed by the openings; and
patterning the insulating layer and the metal layer to form the patterned insulating layer and the metal wirings, wherein the patterned insulating layer further covers the metal wirings.

9. The manufacturing method of the touch panel of claim 8, wherein materials of the insulating layer and the metal layer are light-sensitive materials respectively.

10. The manufacturing method of the touch panel of claim 1, wherein each of the first electrode pads, each of the second electrode pads, and each of the transparent wirings respectively comprise a first sub-layer and a second sub-layer, the first sub-layer is located between the second sub-layer and the substrate, the first sub-layer and the first connecting portions belong to the first transparent conductive material layer, and the second sub-layer and the second connecting portions belong to the second transparent conductive material layer.

11. The manufacturing method of the touch panel of claim 10, wherein each of the metal wirings is located between the first sub-layer and the second sub-layer of one of the transparent wirings.

12. The manufacturing method of the touch panel of claim 11, wherein the patterned insulating layer is further located between the second sub-layers of the transparent wirings and the metal wirings, and the first sub-layer and the second sub-layer of each of the transparent wirings are in contact at an end of the transparent wiring away from the first electrodes and the second electrodes.

13. The manufacturing method of the touch panel of claim 10, wherein the second sub-layer of each of the transparent wirings is located between one of the metal wirings and the first sub-layer respectively.

14. The manufacturing method of the touch panel of claim 10, wherein the first sub-layer of each of the transparent wirings is located between one of the metal wirings and the second sub-layer respectively.

15. The manufacturing method of the touch panel of claim 1, further comprising:
forming a decoration layer on the substrate.

16. A touch panel, comprising:
a substrate;
a plurality of first electrodes disposed on the substrate, wherein each of the first electrodes comprises a plurality of first electrode pads and at least one first connecting portion, and each first connecting portion connects the first electrode pads in series along a first direction;
a plurality of second electrodes disposed on the substrate and disposed with the first electrodes in a staggered manner, wherein each of the second electrodes comprises a plurality of second electrode pads and a plurality of second connecting portions, and each of the second connecting portions connects two adjacent second electrode pads in series along a second direction;
a patterned insulating layer disposed on the substrate and covering the first connecting portions;
a plurality of metal wirings disposed on the substrate, wherein each of the metal wirings is electrically connected to one of the first electrodes or one of the second electrodes; and
a plurality of transparent wirings disposed on the substrate, wherein each of the transparent wirings is electrically connected to one of the first electrodes or one of the second electrodes, wherein each of the transparent wirings is electrically connected to one of the metal wirings respectively and overlapped with the one of the metal wirings.

17. The touch panel of claim 16, wherein each of the first electrode pads, each of the second electrode pads, and each of the transparent wirings respectively comprise a first sub-layer and a second sub-layer, the first sub-layer is located between the second sub-layer and the substrate, the first sub-layer and the first connecting portions belong to a first transparent conductive material layer, and the second sub-layer and the second connecting portions belong to a second transparent conductive material layer.

18. The touch panel of claim 17, wherein a plurality of strip openings respectively extended along the first direction is formed on the first transparent conductive material layer, and two adjacent openings in the second direction define one of the first connecting portions.

19. The touch panel of claim 18, wherein each of the openings is disposed across at least one of the first electrode pads of one of the first electrodes respectively.

20. The touch panel of claim 17, wherein a plurality of annular openings is formed on the first transparent conductive material layer, and each of the annular openings defines one of the first connecting portions.

21. The touch panel of claim 20, wherein the patterned insulating layer exposes two opposite ends of each of the first connecting portions in the first direction.

22. The touch panel of claim 17, wherein each of the metal wirings is located between the first sub-layer and the second sub-layer of one of the transparent wirings respectively.

23. The touch panel of claim 22, wherein the patterned insulating layer is further located between the second sub-layers of the transparent wirings and the metal wirings, and the first sub-layer and the second sub-layer of each of the transparent wirings are in contact at an end of the transparent wiring away from the first electrodes and the second electrodes.

24. The touch panel of claim 17, wherein the second sub-layer of each of the transparent wirings is located between one of the metal wirings and the first sub-layer respectively.

25. The touch panel of claim 17, wherein the first sub-layer of each of the transparent wirings is located between one of the metal wirings and the second sub-layer respectively.

26. The touch panel of claim 16, further comprising:
a decoration layer disposed on the substrate.
